(19) United States
(12) Patent Application Publication
(10) Pub. No.: US 2003/0062866 A1
(43) Pub. Date: Apr. 3, 2003

(54) Antisqueeze protection

(75) Inventors: Rudgerus Bernardus Albertus Elsinghorst, Winterswijk (NL); Hendrikus Bernardus Maria Steentjes, Gaanderen (NL)

Correspondence Address: JACOBSON HOLMAN PLLC, 400 SEVENTH STREET N.W., SUITE 600, WASHINGTON, DC, 20004, US

(73) Assignee: N.V. Nederlandsche Apparatenfabriek NEDAP.

(21) Appl. No.: 10/120,793

(22) Filed: Apr. 12, 2002

Related U.S. Application Data
(63) Continuation of application No. 09/446,124, filed on Nov. 3, 2000, now abandoned.
Application No. 09/446,124 is a 371 of international application No. PCT/NL98/00370, filed on Jun. 25, 1998.

(30) Foreign Application Priority Data
Jun. 25, 1997 (NL) 1006400

(51) Int. Cl. H02P 3/00; H02P 1/00

(52) U.S. Cl. 318/445

(57) ABSTRACT

A device for controlling a movable member for closing or clearing an opening, such as a sliding roof or a window in a door of a vehicle, a direct-current motor being arranged for driving the movable member, and detection means being arranged for detecting a body being caught between the movable member and an edge of the opening. The detection means are arranged to measure the motor current flowing through the direct-current motor and, upon detection of a predetermined increase of the motor current, or a related quantity, to provide a body-caught detection signal. Further, a position sensor is provided, which can measure the displacement of the movable member. A body-caught detection signal is transmitted only after the position sensor has indicated that the movable member has begun to move.

This invention relates to a device for controlling a movable member for closing or clearing an opening at will, suitable in particular for controlling the panel of a sliding roof or a window in a door of a vehicle, a direct-current motor being arranged for driving the movable member, and detection means being arranged for detecting a body being caught between the movable member and an edge of the opening.

A known method is measuring the motor current increase caused by a body being caught. A somewhat more advanced method is measuring a gradient of the motor current increase, i.e., the change per unit of time dI/dt. Such methods are described, e.g., in DE 44 45 106.

When the direct-current motor starts, this will entail a current peak, which will decrease when the motor starts running. Play in the drive, which becomes noticeable especially if the direction of rotation of the motor is reversed, causes a decrease in the motor current, whereupon the motor current rises again as the roof panel or the like begins to move, and then remains reasonably constant.

If there is no play, however, this decrease and the subsequent increase of the motor current will not occur. Therefore, since it is not always clear whether an increase in the motor current is caused by play or by a body being caught, the known methods are not always reliable. This is true in particular if a body is caught very shortly after the beginning of the actuation of the closing movement of the sliding roof or the window or the like.

The object of the invention is to obviate the drawback outlined, and more generally to provide an improved caught-body security facility.

To that end, according co the invention, a device of the type described is characterized in that

the detection means are arranged to measure the motor current flowing through the direct-current motor and, upon detection of a predetermined increase of the motor current or a related quantity, to provide a body-caught detection signal;

that, further, a position sensor is provided, which can measure the displacement of the movable member; and

that means are arranged which provide that a body-caught detection signal is transmitted only after the position sensor has indicated that the movable member has begun to move.

The invention will be further described with reference to the accompanying drawings.

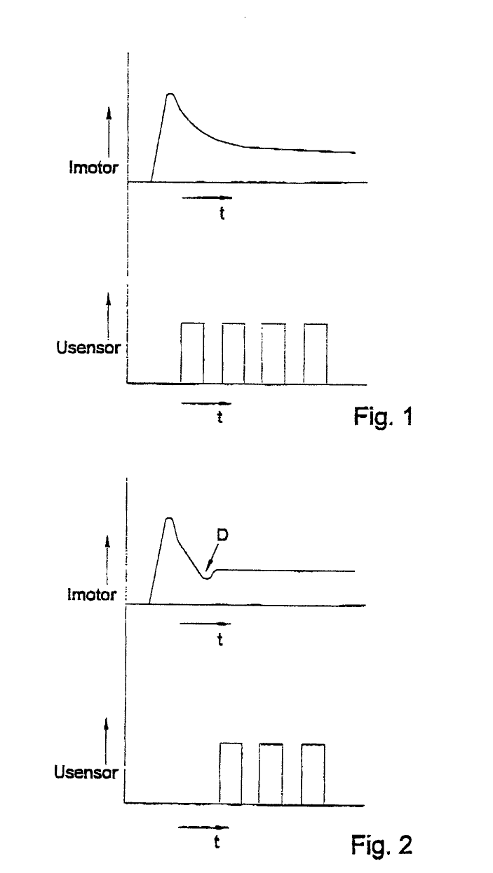

FIG. 1 diagrammatically shows the current of a driving motor for a sliding panel without play, as well as motion information regarding the sliding panel (pulses);

FIG. 2 diagrammatically shows the current of a driving motor of a sliding panel with play, as well as motion information regarding the sliding panel (pulses);

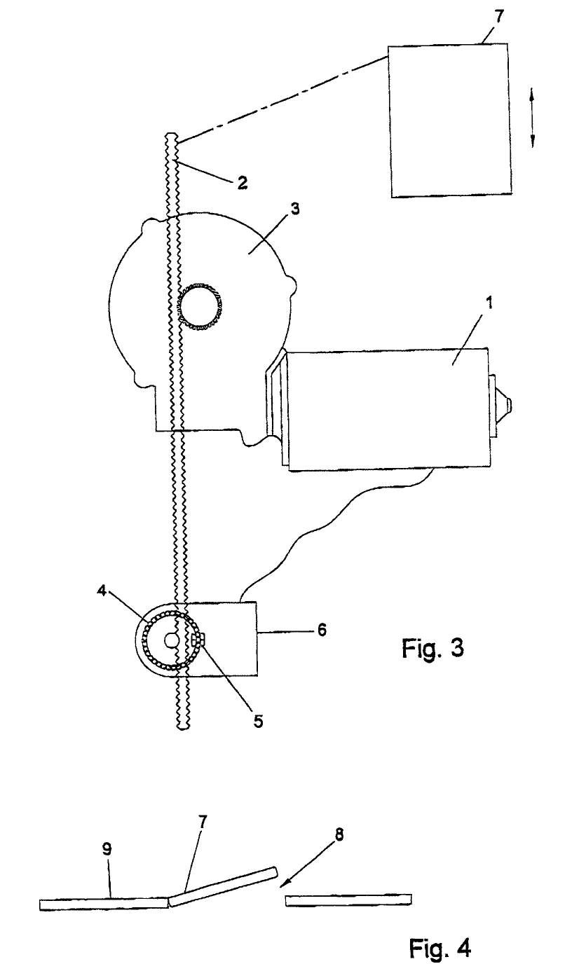

FIG. 3 schematically shows a combination of driving motor, driving cables, crenellation wheel with sensors and movable sliding panel; and

FIG. 4 schematically shows a sliding root whose sliding panel is in the ventilation position.

FIG. 1 shows the motor current Imotor of a direct-current motor driving a movable panel. FIG. 1 also represents the pulses (Usensor) caused by the displacement of the panel, which can be, for instance, a sliding roof panel, a car window, etc., and measured by a position sensor.

FIG. 2 schematically shows an example of the current Imotor drawn by a direct-current motor in the case where the direct-current motor drives a sliding panel via a transmission with some play. The play causes a brief dip D in the motor current, which ends after the play has been absorbed. Similarly to FIG. 1, FIG. 2 further shows a number of pulses obtained in a manner co be described hereinafter, using a sensor operatively detecting the movement of the sliding panel. In this example, the pulses are voltage pulses Usensor, which are a measure for the distance traveled by the sliding panel. A comparison of FIGS. 1 and 2 clearly shows that in the case of play (FIG. 2), the sliding panel begins to move at a later time.

FIG. 3 diagrammatically shows the combination of a motor 1, a transmission element 2, coupled to the motor via a reduction gear unit 3, a crenellate wheel 4, a control unit 6 and a position sensor 5. The transmission element can comprise, for instance, a gear rack, or a driving cable or the like, and drives the sliding panel 7. These voltage pulses Usensor can be obtained, for instance, as follows. The driving element 2 connected to the movable panel and driven by the motor via the reduction 3 causes the panel to move. The driving element 2 also drives a crenellate wheel 4. The crenellations of this wheel move through a position sensor 5 designed as a slotted sensor with an optical transmitter and receiver (not shown) of a control unit 6. If a crenellation interrupts the optical path between transmitter and receiver, this yields a logic, signal (“1”). If a crenellation leaves the optical path between transmitter and receiver, this yields a different logic signal (“0”). By providing that the crenellation wheel 4 is driven by the driving element 2, the play between motor 1, reduction 3 and driving element 2 no longer has any influence on the movement of the crenellation wheel 4.

By monitoring the motor current for, for instance, a predetermined current gradient (dI/dt) from the moment when the flank of the first sensor pulse is detected, any body being caught can be detected immediately after the beginning of the movement of the sliding panel. Alternatively, instead of a current gradient (dI/dt), a change of another quantity, derived from the motor current, for instance a predetermined increase of the motor current, can be taken as signaling a body being caught. If desired, the value of the predetermined current gradient (dI/dt) or of the increase of the current can be made dependent on the instantaneous position of the sliding panel. For instance, the motor current or the gradient thereof or another quantity, related to the motor current may be measured not until the panel has moved over a predetermined distance.

FIG. 4 schematically shows a sliding roof panel in the ventilation position. In a sliding roof having a ventilation position, the roof panel 7, when opened, will generally be in an oblique position with respect to the surrounding roof 9. As a consequence, the weight of the roof panel will by nature cause any play in the transmission to be absorbed. The ventilation opening 8 in a sliding roof is typically not large, and typically only little displacement of the driving cable is needed to close the ventilation opening. For that reason, it is of importance, especially in the ventilation position, to start monitoring the motor current immediately after the start of the movement of the roof panel, since a body might be caught already after a very slight movement from the ventilation position and hence this should be immediately detectable.

After a body-caught situation has been detected, the control unit 6 can feed a signal to the motor 1, causing the motor to stop and/or the direction of rotation of the motor so be reversed.

It is noted that after the foregoing, various modifications will readily occur co those skilled in the art. Thus, a different type of position sensor or a differently driven position sensor may be used, The position sensor may be coupled to the transmission mechanism, but may alternatively be coupled to the sliding panel or, possibly, co the reduction gear unit The position sensor may further comprise a magnetic element and one or more Hall sensors. Also, a potentiometer may be used as position sensor, The position sensor can also be designed as an inductive or capacitive pulse generator. The sliding panel can be any type of panel driven by an electric motor.

1. A device for controlling a movable member for closing or clearing an opening at will, suitable in particular for controlling the panel of a sliding roof or a window in a door of a vehicle, a direct-current motor being arranged for driving the movable member, and detection means being arranged for detecting a body being caught between the movable member and an edge of the opening, characterized in that
the detection means are arranged to measure the motor current flowing through the direct-current motor and, upon detection of a predetermined increase of the motor current or a related quantity, to provide a body-caught detection signal;
that, further, a position sensor is provided, which can measure the displacement of the movable member; and
that means are arranged which provide that a body-caught detection signal is transmitted only after the position sensor has indicated that the movable member has begun to move.

2. A device according to claim 1, characterized in that the quantity related to the motor current is the increase per unit of time.

3. A device according to claim 1 or 2, characterized in that a body-caught detection signal can be transmitted if the position sensor indicates that the movable member has moved over a predetermined distance.

4. A device according to any one of claims 1-3, characterized in that the position sensor is operated by the driving element.

5. A device according to claim 4, characterized in that the driving element is a driving cable.

6. A device according to claims 1-4, characterized in that the position sensor is operated by the motor or motor reduction.

7. A device according to claims 1-4, characterized in that the position sensor is operated by the roof panel.

8. A device according to any one of the preceding claims, characterized in that the sensor comprises a wheel with crenellations and one or more optical transmitters and receivers.

9. A device according to claims 1-8, characterized in that the sensor comprises a wheel with magnets and one or more Hall sensors.

10. A device according to claims 1-8, characterized in that the sensor comprises a potentiometer.

11. A device according to claims 1-8, characterized in that the sensor comprises an inductive pulse generator.

12. A device according to claims 1-8, characterized in that the sensor comprises a capacitive pulse generator.
